(19) United States
(12) Patent Application Publication
(10) Pub. No.: US 2022/0011047 A1
(43) Pub. Date: Jan. 13, 2022

(54) CANNABIS DRYING OVEN

(71) Applicant: GOJI LIMITED, Hamilton (BM)

(72) Inventors: Ben ZICKEL, Qiryat Bialik (IL); Ronen COHEN, Pardesiya (IL); Amir BURSTEIN, Tel Aviv (IL); Tatiana DANOV, Beer Sheva (IL)

(73) Assignee: GOJI LIMITED, Hamilton (BM)

(21) Appl. No.: 17/294,295

(22) PCT Filed: Nov. 18, 2019
(86) PCT No.: PCT/IL2019/051262

§ 371 Date: May 14, 2021

Related U.S. Application Data
(60) Provisional application No. 62/769,005, filed on Nov. 19, 2018.

(51) Int. Cl. F26B 3/347; F26B 9/06; H05B 6/64

(52) U.S. Cl. CPC F26B 3/347; F26B 9/06; H05B 6/6467; H05B 6/642; F26B 2200/02; H05B 6/6455

(57) ABSTRACT

Methods and apparatuses for drying, especially cannabis, are provided. One of the provided methods includes: heating the cannabis in a cavity of a variable frequency microwave oven using at least two different frequencies; measuring temperature of at least 1 cm square of the cannabis at different times during the heating; and controlling the heating based on the temperature measured so that the cannabis is kept for at least 20 minutes at temperatures above 30° C. and below 100° C.

### FIELD AND BACKGROUND OF THE INVENTION

The present invention, in some embodiments thereof, includes methods and apparatuses for drying by microwave radiation, and particularly, but not exclusively, for drying cannabis.

Drying by microwave or other ranges of radio frequency is described, for example, in U.S. Pat. No. 8,839,527 titled Drying Apparatus and Methods and accessories for use therewith.

US patent application publication No. 2018099236 describes, inter alia, applying electric fields to plant material to accelerate dehydration and extraction of target organic compounds from the plant material.

### SUMMARY

An aspect of some embodiments of the disclosure includes a method of drying cannabis.
An exemplary method comprises:

heating the cannabis in a cavity of a variable frequency microwave oven using at least two different excitation setups;

measuring temperature of at least 1 cm square of the cannabis at different times during the heating; and

controlling the heating based on the temperature measured so that the cannabis is kept for at least 20 minutes at temperatures above 30° C. and below 100° C.

In some embodiments, controlling the heating comprises controlling the total microwave power applied to the cavity based on the temperature measured.

In some embodiments, controlling the heating comprises controlling based on feedback received from at least one RF detector in or around the cavity, the feedback being indicative of a heating efficiency of each of the at least two excitation setups.

In some embodiments, controlling the heating comprises controlling so that a substantially equal amount of energy is absorbed in the cavity at each of the at least two excitation setups.

In some such embodiments, each of said at least two excitation setup is a frequency-phase combination.

In some embodiments, the method further comprises setting a value for the equal amount of energy, and controlling the heating based on the set value. Setting the value may include setting based on the measured temperature.

In some embodiments, the method further comprises repeatedly replacing existing air in the vicinity of the cannabis with new air, which is drier and cooler than the existing air. Alternatively, replacing with new air is replacing with air taken from within the cavity, further from the cannabis.

An aspect of some embodiments of the invention includes a cannabis drying oven comprising:

a cavity for receiving therein the cannabis to be dried;

a variable frequency microwave source configured to feed the cavity with microwaves of at least two different excitation setup;

a thermometer, configured to measure temperature of at least 1 cm square of the cannabis in the cavity during heating by the microwaves; and

a processor, configured to control the variable frequency microwave source based on readings received from the thermometer, to heat the cannabis to temperatures of between 30° C. and 100°.

In some embodiments, the processor is configured to control the microwave power applied by the source to the cavity based on the temperature measured by the thermometer.

In some embodiments, the cavity is sized to support at least two modes in a frequency range spanned by the at least two excitation setups.

In some embodiments, the thermometer is an IR thermometer. The IR thermometer may have a field of view encompassing at least a quarter, optionally third or more of the cannabis to be heated.

In some embodiments the cannabis drying oven further comprises at least one detector arranged in or around the cavity and configured to provide the processor with feedback indicative of an absorption efficiency of each of the at least two excitation setups.

In some embodiments, the processor is configured to control the heating so that a substantially equal amount of energy is absorbed in the cavity at each of the at least two excitation setups. The processor may further be configured to set a value for the equal amount of energy, and control the heating based on the set value. The processor may be configured to set the value of the equal amount based on readings received from the thermometer.

In some embodiments, the cannabis drying oven further comprises a pump, configured to repeatedly replace existing air in the vicinity of the cannabis with new air, which is drier and cooler from the existing air.

In some embodiments, the pump is configured to replace air from the vicinity of the cannabis with air from outside the cavity. Alternatively or additionally, the oven may include a pump configured to circulate air inside the cavity, through a heat exchange and a desiccant.

An aspect of some embodiments of the disclosure includes a method of drying an object in a cavity, the method comprising:

applying to the cavity RF energy at frequencies that excite in the cavity, when the cavity is empty, a plurality of modes;

passing air through the cavity to reduce humidity in the vicinity of the object;

measuring temperature of at least 1 cm square of the object; and

controlling the application of the RF energy to retain the temperature within a predetermined temperature range.

In some embodiments, the object comprises cannabis buds.

In some embodiments, the temperature range has a lower limit of 30° C. or higher.

In some embodiments, the method is carried out with the object under atmospheric pressure.

In some embodiments, the RF energy is applied via a plurality of radiating elements, optionally, simultaneously at a common frequency and at different phase differences so as to apply to the object multiple field patterns at the common frequency.

In some embodiments, controlling the application of the RF energy comprises controlling application at different frequencies so that less forward energy is applied at frequencies that are better absorbed.

In some embodiments, controlling the application of the RF energy comprises controlling application at different excitation setups so that essentially the same amount of energy is absorbed at each of the excitation setups.

In some embodiments, controlling the application of the RF energy comprises controlling RF energy application at a common frequency and at different field patterns so that less forward energy is applied at field patterns that are better absorbed. Optionally, essentially the same amount of energy (i.e., the same±10%) is absorbed at each of the field patterns.

In some embodiments, the predetermined temperature range is between 30° C. and 100° C.

In some embodiments, the predetermined temperature range has a width of between 5° C. and 15° C.

In some embodiments, the predetermined temperature range is between 40° C. and 50° C.

In some embodiments, the measuring of the temperature is by an IR thermometer.

In some embodiments, the temperature being measured is of at least 50% of the object.

In some embodiments, the object comprises leaves to be dried.

In some embodiments, the object comprises cannabis.

In some embodiments, the passing air through the cavity comprises bringing air from outside the cavity into cavity, and taking air from within the cavity to outside the cavity. Optionally, the air brought from outside the cavity is at a lower temperature than air near the object.

In some embodiments, the passing air though the cavity comprises circulating the air in the cavity through a desiccant, so that the desiccant absorbs humidity from the air. Optionally, circulating the air comprises contacting the air with a heat exchanger for cooling the air to below the temperature of the air near the object.

In some embodiments, the frequencies at which the RF energy is applied excite in the cavity, when the cavity is empty, at least 10 modes.

An aspect of some embodiments of the invention includes a method of determining if to stop or continue with heating by microwaves, the method comprising:

accessing data indicative of a heating efficiency threshold;

accessing data indicative of a threshold number of excitation setups;

accessing data indicative of a number of excitation setups associated with a heating efficiency larger than the dissipation ratio threshold;

comparing the number of excitation setups with the threshold number of excitation setups; and

determining if to stop or continue the heating based on the comparison.

Preferably, the determination is to stop the heating only if the number of excitation setups is smaller than the threshold.

An aspect of some embodiments of the invention includes a method of determining if to stop or continue with heating by microwaves, the method comprising:

accessing data indicative of a heating efficiency threshold;

accessing data indicative of a threshold time derivative of a number of efficient excitation setups, wherein an efficient excitation setup is an excitation setup associated with a heating efficiency higher than the heating efficiency threshold;

accessing data indicative of a time derivative of the number of efficient excitation setups;

comparing the time derivative of the number of efficient excitation setups with the threshold time derivative of the number of efficient excitation setups; and

determining if to stop or continue the heating based on the comparison.

Preferably, the determination is to stop the heating only if the time derivative of the number efficient excitation setups is smaller than the threshold.

An aspect of some embodiments of the invention includes a drying oven comprising a cavity for receiving therein an object to be dried; a variable frequency microwave source configured to feed the cavity with microwaves of at least two different excitation setup; and a processor, configured to determine if heating is to be stopped or continued using a method described above, and to stop or continue the heating according to the determination.

In embodiments, the drying oven is further configured to dry cannabis, or any other object in a method described above.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such as measuring dielectric properties of a tissue might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flowchart of a method of drying cannabis, according to some embodiments of the presently disclosed inventions;

FIG. 2 is a diagrammatic representation of an oven configured to carry out a heating method according to some embodiments;

FIG. 3 is a diagrammatic representation of a cavity door of an oven according to some embodiments;

FIG. 4 is a diagrammatical illustration of a system for air replacement according to some embodiments;

FIG. 5 is a simplified flowchart of method of drying an object in a cavity according to some embodiments;

FIG. 6 and FIG. 7 are simplified flowcharts of a methods of determining if to stop or continue with heating by microwaves according to some embodiments.

### DETAILED DESCRIPTION

An aspect of some embodiments of the invention includes a method of drying cannabis. Cannabis is usually dried to make it suitable for on-demand activation by heat. It is a general belief in the field that the cannabis is to be dried slowly and at low temperatures, typically of between 18° C. and 26° C. The inventors surprisingly found that cannabis may be dried much more quickly at higher temperatures, by using uniform microwave heating. Preferably, the microwave heating is controlled based on temperature reading taken from the cannabis. It was found that at least one cm square of the cannabis has to be probed for its temperature in order to obtain adequate control of the heating, with probing larger surfaces of the cannabis, e.g., 10 cm², 30 cm², or 50 cm² is preferable. The percentage of the cannabis to be dried that should be probed is at least 1%, but higher percentage may be preferable, for example, 10%, 30%, 50%, or intermediate or higher percentages.

Examples of temperatures found to be useful for cannabis drying include 30° C., 40° C., 50° C., and more generally temperatures between 30° C. and about 100° C. These temperatures are of the cannabis outer surface as measured, for example, by an IR probe, having a field of view of the above-mentioned areas (i.e., between 1 cm² and 50 cm² or larger). It is to be noted that it is not only that these temperatures are reached during the heating, but that the cannabis temperature is kept within this temperature range for a period of at least 20 minutes, and typically between 1 and 3 hours.

The heating may be controlled based on the temperature readings, for example, to keep the cannabis (or, more precisely, that part of the cannabis surface, the temperature of which is being measured) at a predetermined temperature range. This temperature range may be narrow (e.g., 5° C.), medium (e.g., 10° C.) or broad (e.g., 15° C.). Preferably, the lower edge of this temperature range is 30° C. or higher. Narrower temperature ranges may result in more reproducible drying results. The heating may be controlled using a thermometer that reads temperatures from the cannabis surface, and sends them to a controller, and the controller controls the heating so that the temperature remains within a predetermined temperature range. In some embodiments, the total amount of energy applied to the cavity during a certain time period is controlled based on the temperature, and how this amount of energy is distributed among different excitation setups (explained below) is determined to maximize heating uniformity.

As for the uniformity of the microwave heating, it was found to be accomplished by exciting in the microwave oven cavity at least two different and distinct patterns of electrical field, also referred to herein as field patterns. Field patterns may be estimated by calculation and/or simulation, e.g., based on knowledge of the structure of the cavity, the location of the radiating element introducing the electrical field into the cavity, and the dielectric properties of the cannabis. However, knowledge of the field patterns is not crucial for the invention. For example, in some embodiments, it is sufficient to estimate the field patterns, and selecting field patterns (or corresponding excitation setups) that their estimated patterns sum up to provide improved heating uniformity in comparison to the uniformity obtained by using each of them alone. The estimation may be based, for example on an approximation that the field pattern excited in the presence of the cannabis is the same as that excited in the empty cavity.

Different field patterns may be excited in the cavity using different frequencies. Thus, in some embodiments, the cannabis is dried with a frequency variable microwave oven, using at least two frequencies. In some embodiments, e.g., when the cavity has two equal dimensions (e.g., equal length and width or circular cross section), several different field patterns may be excited in the cavity at a common frequency, for example, by introducing the field into the cavity via different radiating elements (at different times) or by introducing the field into the cavity simultaneously by two or more radiating elements, when the phase difference between the fields emitted by the radiating elements differ. In some embodiments, each phase difference (or phase difference combination, in case there are more than two radiating elements emitting together at the same frequency) may correspond to a different field pattern. The term “phase” is used herein to refer to both phase difference and phase difference combination.

More generally, there may be many different parameters that may be controlled to change the field pattern excited in the cavity, and each such parameter may be referred to as a controllable field affecting parameter (c-FAP). A set of c-FAPs may be determined by determining an excitation setup that is, determining a set of values, a value for each c-FAP controllable by the microwave oven at hand. For example, some microwave ovens may allow only controlling the frequency, so the excitation setup is a set that includes a value for only one c-FAP (that is, the frequency). In another example, some microwave ovens may also allow control of the radiating element emitting the microwave, in which case, the excitation setup is two-dimensional, as it may include one value for the frequency, and another value for the emitting radiating element. Some non-limiting examples of c-FAPs include: frequency, phase difference between two signals of the same frequency, emitted simultaneously from two radiating elements; amplitude ratio between two signals of the same frequency, emitted simultaneously from two radiating elements; location of an emitting radiating element, location and/or orientation of a field adjusting element, etc.

In some embodiments, cannabis is heated by microwaves applied at a plurality of excitation setups. The excitation setups may be selected so that at least as long as the cavity is empty, they excite in the cavity different field patterns. In some preferred embodiments, the different field patterns are complimentary, in the sense that some regions heated more by one field pattern is heated less by another. Generally, the more field patterns are used, the higher is the chance to obtain a uniform heating. This is so particularly if the field patterns are not correlated with each other. If they are correlated, for example, if complementary field patterns are purposefully selected, a small number of field patterns may be sufficient. If field patterns with hot spots at the same places are selected, enlarging the number of the field patterns will not help. In some embodiments, at least five field patterns (or excitation setups) are used to obtain the required conditions for fast cannabis drying that does not deteriorate the taste of the cannabis when dry.

Thus, according to some embodiments of the invention, the cannabis drying method comprises:

heating the cannabis in a cavity of a microwave oven using at least 2 different excitation setups;

measuring temperature of at least 1 cm square of the cannabis at different times during the heating; and

controlling the heating based on the temperature measured so that the cannabis is kept for at least 20 minutes at temperatures above 30° C. and below 100° C.

In some such embodiments, controlling the heating comprises controlling the total microwave power applied to the cavity based on the temperature measured. Optionally, controlling the heating also comprises controlling to enhance heating uniformity.

In some embodiments, controlling the heating to enhance heating uniformity may include controlling based on feedback indicative of a heating efficiency of each of the at least two excitation setups. The feedback may be received from at least one RF detector in or around the cavity. For example, the heating may be controlled so that a substantially equal amount of energy is absorbed in the cavity at each of the at least two excitation setups. Two amounts may be said to be substantially equal when the difference between them is no more than 10% of their average. An amount of energy absorbed in the cavity at a specific excitation setup may be estimated, for example, as the multiplicative product of the amount of energy applied to the radiating elements, multiplied by a dissipation ratio. The dissipation ratio may be defined as the ratio between the amount of energy absorbed and the amount of energy applied. The amount of energy absorbed may be estimated as a difference between the amount of energy applied and an amount of energy measured to get out of the cavity. For example, in case a single radiating element is provided, the amount of energy absorbed is the difference between the amount of energy measured to go to the radiating element towards the cavity (i.e., forward), and the amount of energy measured to go to the radiating element from the cavity (i.e., backward). An equation for the dissipation ratio in this case may be:

$$D R = \frac{{E}_{f} - {E}_{b}}{{E}_{f}} = 1 - \frac{{E}_{b}}{{E}_{f}} = 1 - \frac{{P}_{b}}{{P}_{f}} \qquad ( Eq . 1 )$$

Wherein DR is the dissipation ratio, E_{f} is the energy measured to go forward through the radiating element; E_{b} is the energy measured to go back from the cavity towards the radiating element. If all the measurements are made for the same period of time, the energy values may be replaced by power values, with P_{f} being the power measured to go forward through the radiating element; and P_{b} being the power measured to go back from the cavity towards the radiating element.

In case more than one radiating element is provided, and each is used to emit RF radiation at different times and/or different frequencies, a dissipation ratio may be associated with a radiating element, and be given by the following equation:

$$D {R}_{i} = 1 - \frac{{\sum }_{j = 1}^{n} {P}_{{j}_{b}}}{{P}_{{i}_{f}}} \qquad ( Eq . 2 )$$

Wherein DRᵢ is the dissipation ratio associated with radiating element i, Pᵢ_{_{f}} is the power measured to go forward towards the cavity through radiating element i, and Σⱼ₌₁ⁿPⱼ_{_{b}} is the sum of the amounts of power measured to go backward from the cavity through each of the radiating elements (including radiating element i itself).

If different radiating elements emit microwaves of a common frequency, these microwaves interfere with each other, and the dissipation ratio may be defined for the entire cavity at the given excitation setup, and given by the following equation:

$$DR = 1 - \frac{{\sum }_{i = 1}^{n} {\vert {\sum }_{k = 1}^{n} {S}_{i k} {a}_{k} {e}^{j {φ}_{k}} \vert}^{2}}{{\sum }_{k = 1}^{n} {a}_{k}^{2}} \qquad ( Eq . 3 )$$

wherein Sᵢₖ is a scattering parameter (also referred to as S parameter), defined as

$${S}_{i k} = \frac{{V}_{i}^{-}}{{V}_{k}^{+}} ,$$

where Vᵢ⁻ is voltage received at radiating element i when voltage Vₖ⁺ is supplied to radiating element k at an amplitude aₖ, and φₖ is the phase difference between voltage supplied to radiating elements k and i. The S parameters may be represented as complex numbers, and each may have a magnitude and a phase. When used herein, the term “phase” is used to refer to the phase of an S parameter only if it is explicitly stated. All other uses of phase are phase differences between waves emitted by different radiating elements. The S parameters may be indicative of the electrical response of the cavity to electrical signal applied to the cavity. This response may depend upon the presence and/or nature of an object in the cavity. Therefore, the electrical response (or S parameters) may be attributed to the cavity and the object.

Alternatively, the DR may be defined as the ratio between total power input to the cavity (i.e., the sum of power levels put into all the radiating elements) and total power output from the cavity (i.e., the sum of power levels received from the cavity by all the radiating elements). In these embodiments, the dissipation ratio for an excitation setup may be defined as:

$$D R = 1 - \frac{{\sum }_{j = 1}^{n} {P}_{{j}_{b}}}{{\sum }_{j = 1}^{n} {P}_{{j}_{f}}} \qquad ( Eq . 4 )$$

Wherein DR is the dissipation ratio associated with an excitation setup, Σⱼ₌₁ⁿPⱼ_{_{b}} is a sum of the power levels measured to go forward towards the cavity through each of the radiating elements (i.e., total forward power), and Σⱼ₌₁ⁿPⱼ_{_{b}} is the sum of the power levels measured to go backward from the cavity through each of the radiating elements (i.e., total backward power).

The dissipation ratio is a measure for the ability of the cannabis (or any other object being dried) to absorb microwave energy at a particular excitation setup. As each excitation setup is associated with a field pattern, the dissipation ratio may also serve as a measure for the ability of the object to absorb microwave energy at particular regions that overlap with the field pattern of the respective excitation setup. It is noted, however, that there may be additional measures for these abilities, for example, 1-DR, 1/DR, 1/(1-DR), etc. All these may be referred to herein collectively as absorption indicators, and in short AIs. It is noted that some absorption indicators (e.g., DR) are larger when the absorption is larger, and these will be referred to herein collectively as direct absorption indicators. Some of absorption indicators are smaller when the absorption is larger (e.g., 1-DR), and these will be referred here collectively as inverse absorption indicators.

In some embodiments, the dissipation ratio (or any other AI) is determined using a reduced power, at which only nominal heating takes place. This may require amplifiers with a broad range of amplification gains. Alternatively, the AI is determined using the same power level at which heating takes place. This may be advantageous, as it may allow using less expensive amplifiers that have to provide power only in a relatively narrow range of amplification gains, or even amplifiers configured to output a single predetermined power level.

The amount of absorbed energy may be equated with a multiplicative product of the incident energy, applied through the radiating element(s), and the appropriate dissipation ratio. In some embodiments, when the temperature is measured to be below a desired threshold, excitation setups with higher direct absorption indicators, such as dissipation ratios are selected for energy application, so that the heating becomes more efficient. Alternatively or additionally, the amount of energy applied at each excitation setup is increased.

In some embodiments, heating is controlled so that a substantially equal amount of energy is absorbed in the cavity at each excitation setup. For example, the DR is measured for each excitation setup, and energy is applied at each excitation setup so that the energy absorbed at each excitation setup is substantially equal. In other words, the higher is the absorption efficiency (or dissipation ratio, or any other direct absorption indicator) at a given excitation setup, the lower is the amount of forward energy applied at that excitation setup. The forward energy applied may be controlled by controlling the forward power, the time of power application, or a combination thereof.

Thus, some embodiments of the present cannabis drying method, include setting a value for the equal amount of energy to be absorbed at each excitation setup, and controlling the heating based on the set value. Setting the value may include, in some embodiments, setting based on the measured temperature for example, as a constant multiplied by a difference between the measured temperature and the target temperature.

In some embodiments, the forward power is determined based on the temperature, for example, it may be proportional to a difference between the target temperature and the measured temperature (e.g., the highest temperature measured by the various thermometer-elements making together an IR thermometer). In some embodiments, the time duration, for which each excitation setup is transmitted is constant at the forward power level determined based on the temperature. Alternatively, the time duration may depend upon the dissipation ratio or any other absorption indicator. For example, each excitation setup may be transmitted for a constant, predetermined, time duration, unless the dissipation ratio associated therewith is below a predetermined threshold, in which case, the excitation setup is not used at all for the drying. To equalize the energy absorbed at the various excitation setups, the time duration for which each excitation setup is used may be inversely proportional to the dissipation ratio associated with that excitation setup.

Making the absorbed power substantially equal across different excitation setups may result in equal energy being absorbed at different field patterns, so if the field patterns are substantially complimentary, or their number is large, the uniformity of the heating is increased in comparison to embodiments where the amount of energy applied at each excitation setup is independent of the heating efficiency at that excitation setup. This amount of energy itself, absorbed at each of the excitation setups, may be determined based on the measured temperature, for example, based on the difference between the measured temperature and a target temperature. For example, in some embodiments, if this difference is larger (that is, a lot of heating has still to take place before the target energy is reached), the amount of energy to be absorbed at each excitation setup may be larger than if the measured temperature is closer to the target temperature. In some embodiments, each excitation setup is applied for the same time period, and the energy application is controlled by controlling the applied power. This is generally true for all the embodiments described herein that deal with controlling amount(s) of energy.

In some embodiments, the amount of energy absorbed is determined not by measuring incident, reflected, and coupled energies or powers, but rather based on the temperature measurement. For example, if the temperature rises quickly, this may be indicative to the amount of energy absorbed by the cannabis being large, in comparison to conditions under which the temperature rises more slowly. Thus, in some embodiments, each excitation setup may be associated with a corresponding heating pace, and more power is applied at excitation setups where the heating pace is slower than in excitation setups where the heating pace is faster.

In some embodiments of the invention, in addition to heating control, the drying method may also include air replacement in the vicinity of the cannabis. In other words, air from the vicinity of the cannabis is pumped away, and fresh, new air is pumped towards the cannabis. In some embodiments, air replacement is carried out using a fan, similar to that used in convection ovens to circulate the hot air in the oven cavity. In some such embodiments, the cavity is partially open, to allow air to leave the cavity. The cavity optionally has a plurality, (e.g., more than 20, more than 50, etc.) openings, which are small enough to prevent microwave leakage, but large enough to allow air to come in and out of the cavity. Optionally, the fan is turned on and off, for example, to allow air return into the cavity and/or to prevent the fanned air from cooling the cannabis too much. In some embodiments, the fan works continuously, but at sufficiently low power not to cool the cannabis. As air replacement may cause cooling, in some embodiments it is increased when the measured temperature approaches the target temperature, thereby facilitating keeping the cannabis being heated to increase its dryness, without increasing its temperature. In some embodiments, the air is pumped out of the microwave oven cavity, and the new air is brought from outside the cavity into the cavity and towards the cannabis, optionally, through a desiccator. In some embodiments, there is air circulation inside the cavity, and air is pumped away from the vicinity of the cannabis without leaving the cavity, dried and cooled, and returned to the vicinity of the cannabis. The drying may be by means of a desiccator, and the cooling may be by a heat exchanger. Residues from the cooled air may be collected, e.g., by extracting them from the air into an alcoholic solution, oil, or any other suitable solvent.

An aspect of some embodiments of the invention includes a cannabis drying oven configured to carry out one or more of the cannabis drying methods described herein. In particular, according to this aspect, a cannabis drying oven comprises a cavity for receiving the cannabis to be dried; a microwave source configured to feed the cavity with microwaves using at least two excitation setups; a thermometer, configured to measure temperature of at least 1 cm square of the cannabis in the cavity during heating by the microwaves; and a processor, configured to control the microwave source based on readings received from the thermometer, to heat the cannabis to temperatures of between 30° C. and 100°.

In some embodiments, the cavity is sized to support at least two different modes, e.g., a different mode per excitation setup.

In some embodiments, the thermometer is an IR thermometer, configured to receive IR radiation, and indicate the temperature of the IR radiation source based on the received IR radiation. The IR thermometer is facing the cannabis, and the temperature indicated by the thermometer may be attributed to the cannabis within the field of view of the IR thermometer. Preferably, the cannabis fills the entire field of view of the thermometer. The size of the field of view of the thermometer may be from about 1 cm² to several hundreds of cm², e.g., 10 cm², 30 cm², or 50 cm², or 100 cm². In some embodiments, between about X and % of the cannabis surface (e.g. about a third of the cannabis surface) is within the field of view of the thermometer.

In some embodiments, the IR thermometer includes an array of a plurality of thermometers arranged to have a different field of view each. In some embodiments, the different fields of view don't overlap. A thermometer array, whether with or without overlap between fields of view of different thermometer elements in the array, may provide an indication of the temperature distribution across the cannabis surface. In some embodiments of the invention, the excitation setups used for heating may be selected based on the temperature distribution measured by the thermometer array. For example, in some embodiments, the heating is controlled based on the peak of the temperature distribution. The peak of the temperature distribution is defined, in such embodiments, as the highest of all the temperatures indicated by the different thermometer elements. In some such embodiments, the power transmitted into the radiating elements is set to be proportional to a difference between the peak of the temperature distribution and a target temperature. The proportionality constant may be predetermined, e.g., in the factory, or indicated by the user, e.g., using a user interface. Similarly, the target temperature may be set in advanced, e.g., by a user using a user interface, or at the factory.

Alternatively, more details of the temperature distribution may be used for controlling the heating. For example, in some embodiments, only excitation setups expected to form field patterns having maxima at regions that show lower temperature and minima at regions that show higher temperature may be selected for heating, so that the temperature becomes more uniform. In some embodiments, not only such excitation setups are used, but they are used for longer time periods and/or for shorter durations. The expected field distribution associated with an excitation setup may be determined, for example, based on simulations, or any other way, described, for example, in Applicants' patent application published as WO2011138675. The total energy to be applied using the one or more selected excitation setups may be determined, for example, on the difference between the average temperature of the cannabis surface and a target average temperature. In embodiments where a single temperature value is measured, the total energy to be applied using all the excitation setups may be determined based on a difference between a target temperature value and the measured temperature value.

In some embodiments, the cannabis drying oven further includes at least one detector arranged in or around the cavity, and configured to provide the processor with feedback indicative of a heating efficiency of each of the excitation setups used for the heating. In such embodiments, the energy applied at each of the excitation setups may be determined based on the contribution it is expected to have on the temperature distribution, and a target temperature distribution. In some embodiments, the temperature distributions (measured, target, and/or the difference between them) may be used for determining a spatial energy distribution, for example, assuming a heat capacity of the cannabis and taking into consideration the energy absorption efficiencies of the different excitation setups, as measured by the detector.

In some embodiments, the processor of the oven is configured to control the heating so that a substantially equal amount of energy is absorbed in the cavity at each of the excitation setups used for heating. For example, the absorption efficiency may be estimated based on the measurements as explained above, and the amount of forward energy or power emitted at each excitation setup may be determined so that its multiplicative product with the absorption efficiency is the same for all the excitation setups. In some such embodiments, the processor is further configured to set a value for the equal amount of energy, and control the heating based on the set value. For example, the power distribution between different excitation setups may be determined based on the absorption efficiencies and a uniformity requirement, while the amount of energy or power absorbed by each excitation setup (or by the total of excitation setups) is determined based on the measured temperature, for example, more total power may be set to be absorbed at each excitation setup as the distance between the measured temperature and a target temperature is larger.

In some embodiments, the cannabis drying oven further includes air-replacement device, comprising a pump or a fan. The air-replacement device is configured to replace air in the vicinity of the cannabis with fresh air, which is preferably drier and cooler than the air taken away from the vicinity of the cannabis. Optionally, the air-replacing device does not change the air pressure inside the cavity.

For example, the air-replacement device may include a pump, configured to repeatedly replace existing air in the vicinity of the cannabis with new air, which is drier and cooler from the existing air. For example, the pump may be configured to take air out of the vicinity of the cannabis, and blow cooler air on the cannabis. In some embodiments, the cooler air may include the air pumped away from the cannabis, after being cooled, e.g., over a heat exchanger. In some embodiments, alternatively or additionally to being cooler, the new air is drier than the air pumped away from the cannabis. For example, the new air may include the air pumped away from the cannabis after passing it through a desiccant. In some such embodiments, the pipe is configured to circulate air inside the cavity, through a heat exchange and a desiccant. In some embodiments, the new air is from outside the cavity, where the ambient temperature is lower than the temperature near the cannabis surface, and/or the humidity is lower. Air from outside the cavity may be cooled and/or dried before or after entering the cavity. In some embodiments, a fan takes air out of the cavity, and an opening to the cavity allows air from outside the cavity to enter, thereby replacing the air in the vicinity of the cannabis with fresh air, which may be drier and/or cooler. In some such embodiments, the opening in the cavity is covered with a metallic mesh configured to allow air to go in and out nearly freely, while preventing microwaves from leaking from the cavity. The mesh may be, for example, of the kind used in commercially available microwave ovens for preventing microwave leakage from the cavity through the glass portion of the door, which allows a user to inspect the inside of the oven during the oven's operation.

An aspect of some embodiments of the invention includes a method of determining when to stop heating. The inventors found that during drying, the number of excitation setups that heat effectively decreases. An excitation setup may be considered to heat effectively if it has a direct absorption indicator (such as DR) above a threshold or an inverse absorption indicator (such as 1-DR) below a threshold. Accordingly, when drying completes, the number of efficient excitation setups is low, for example, lower than a predetermined number threshold. In some embodiments that discovery is used to control the heating so that when the number of efficient excitation setups is smaller than the number threshold, heating is stopped. Put otherwise, only if the number of efficient excitation setups is larger than a threshold, drying continues.

Without being bound to theory, it is suggested that the decrease in the number of efficient excitation setups near the end of the drying can be explained in that drying is usually accompanied by a decrease in absorption efficiency of microwave, since water are very good microwave absorbers, and as they evaporate, so does the ability to absorb microwave efficiently. The inventors found that as drying proceeds, some regions become dry before others, so that near the end only some spots are not dry. It is suggested that the excitation setups that are associated with field patterns having maximum magnitude at these spots are the only ones that remain efficient heaters. Therefore, the reduction in heating efficiency is not uniform across the cannabis, and also not across different excitation setups.

Furthermore, it was found by the inventors that the number of efficient excitation setups decreases more and more rapidly in the last stages of drying. Thus, in some embodiments, the decrease in the number of efficient excitation setups serves as a criterion to stop heating. For example, a threshold may be predetermined for the decrease in this number, and if the decrease found during drying is more rapid, drying is stopped. In other words, only if the time derivative of the number of efficient excitation setups is larger (less negative) than a threshold, drying continues.

An aspect of some embodiments of the invention comprises a general heating method, not necessarily limited to heating cannabis. Nevertheless, this heating method may be applied to heating cannabis buds, or other parts of cannabis, and achieves faster drying than achievable by other methods known to the inventors, while maintaining the taste of the cannabis. The method may be suitable also for drying other kinds of leaves and/or plants.

For example, a method of drying an object in a cavity according to this aspect may include: applying to the cavity RF energy at frequencies that excite a plurality of modes in the cavity when the cavity is empty; passing air through the cavity to reduce humidity in the vicinity of the object; measuring temperature of at least 1 cm square of the object, preferably between quarter and half of a surface of the object. The temperature may be measured, for example, by an IR thermometer. The method further includes controlling the application of the RF energy to retain the measured temperature within a predetermined temperature range. The temperature range may have a lower limit of 30° C. or higher. In some embodiments, the temperature range has an upper limit of 100° C. or less. It is noted that prior art driers use sometimes reduced pressure, for example, to dry objects faster. In some embodiments of the present invention this is not required, and the drying may be carried out with the object under atmospheric pressure, that is, without manipulating the pressure in the cavity. In some embodiments, the temperature range is for example, between 5° C. and 15° C., between 30° C. and 35° C., between 30° C. and 100° C., between 40° C. and 50° C., etc.

In some embodiments, the RF energy is applied via a plurality of radiating elements. For example, it may be applied simultaneously via the different radiating elements at a common frequency and at different phase differences between waves transmitted via the different radiating elements (referred to hereinafter as different phases) so as to apply to the object multiple field patterns at the common frequency.

As in the preceding aspect, according to the present aspect of a general heating method, the application of the RF energy may include application at different excitation setups. The excitation setups may differ from each other by at least one of frequency and phase difference. For example, the plurality of excitation setups may consist of excitation setups that differ from each other by frequency only, phase only, or by both frequency and phase. It is noted that in some embodiments it is preferable to have the largest possible number of field patterns, and in such embodiments, using excitation setups that at least some of them differ by both frequency and phase is preferred. For example, in some such embodiments, all available frequency-phase combinations will be used. Optionally, the energy is applied at the different excitation setups so that less forward energy is applied at excitation setups that are better absorbed. For example, the amount of forward energy applied at each excitation setup may be set so that the amount of energy absorbed by the cavity at each of the excitation setups is the same. Similarly, the method may include application of RF energy at different excitation setups so that different field patterns are excited in the cavity, and the application is controlled so that more energy is applied at field patterns that have smaller absorption (e.g., smaller DR). For example, substantially the same amount of energy may be absorbed at each of the field patterns.

As for passing the air through the cavity, it may include bringing air from outside the cavity into the cavity, and taking air from within the cavity to outside the cavity and/or letting air go from within the cavity to outside the cavity, for example, with an opening as described above. The air brought from outside the cavity may be at a lower temperature than air near the object, because the drying may cause vapor to leave the object into the cavity, and this vapor may carry with it the heat. In some embodiments, the air is passed through the cavity is cavity-air, circulated inside the cavity, possibly via a desiccant, so that the desiccant absorbs humidity from the air evacuated from near the object, before this air is blown again to the vicinity of the object to carry away further vapor from the object. The air may also be cooled, e.g., by a heat exchanger, before being blown to the vicinity of the object.

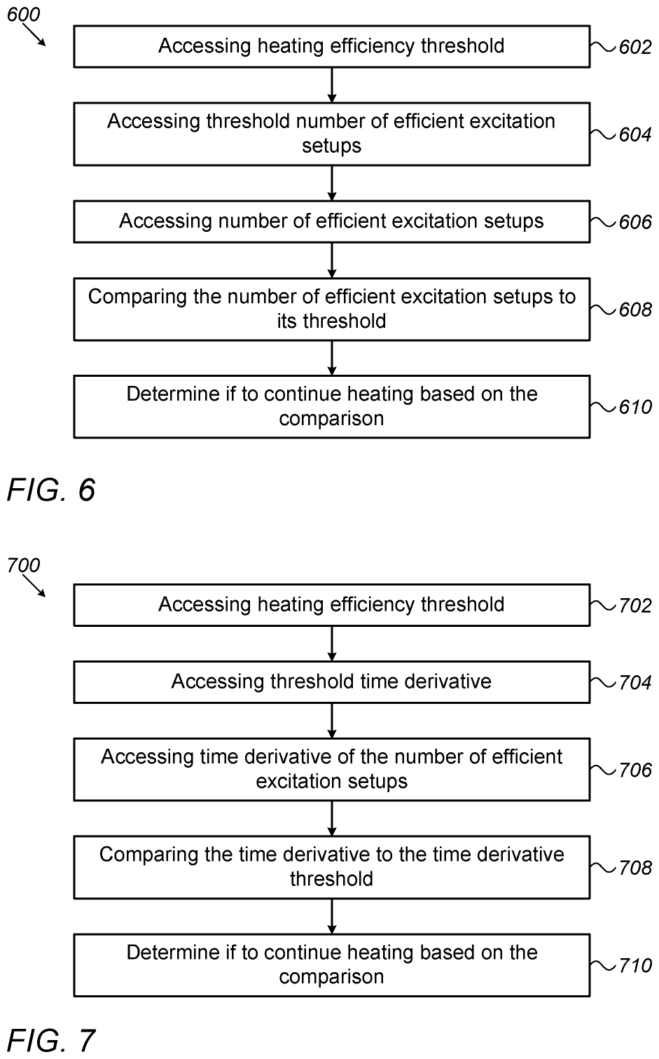

FIG. 6 is a simplified flowchart of a method 600 of determining if to stop or continue with heating by microwaves, e.g., for drying, and in particular embodiments, for drying cannabis. The method includes a step 602 of accessing data indicative of a heating efficiency threshold. In some embodiments, excitation setups associated with heating efficiency lower than the threshold are not used for the heating. Nevertheless, in some embodiments, a decision whether to select an excitation setup for heating or not does not necessarily depend on the heating efficiency threshold. For example, in some embodiments all the excitation setups are used for the heating regardless of their heating efficiency (even if not for the same time periods and/or at the same power levels). In some embodiments, the decision whether to use an excitation setup for heating or not depends on a different threshold, e.g., a second heating efficiency threshold that may be higher or lower than the first. In some embodiments, the selection of excitation setups for heating may be based on other criteria as described herein. The heating efficiency threshold accessed in that step of the method may be determined in advance, for example, in the factory manufacturing an oven that carries out the method or by input from a user, before heating commences.

Method 600 also includes a step 604 of accessing data indicative of a threshold number of excitation setups. This number may also may be determined in advance, for example, in the factory manufacturing an oven that carries out the method or by input from a user, before heating commences.

Method 600 also includes a step 606 of accessing data indicative of a number of excitation setups associated with a heating efficiency larger than the heating efficiency threshold accessed in step 602. This data is generated during sweeping over excitation setups: each excitation setup is applied, its heating efficiency is measured, and associated therewith. The number of excitation setups associated with heating efficiency higher than the heating efficiency threshold is counted, e.g., during or after the sweeping.

Method 600 also includes a step 608 of comparing the number of excitation setups accessed in step 606 with the threshold number of excitation setups accessed in step 604.

Finally, method 600 includes step 610, in which it is determined if to stop or continue the heating based on the comparison between the number of efficient excitation setups and the threshold number of excitation setups. For example, the determination may be to stop the heating only if the number of efficient excitation setups is smaller than the threshold number, while if it is larger than the threshold number, heating continues.

FIG. 7 is a simplified flowchart of a method 700 of determining if to stop or continue with heating by microwaves, e.g., for drying, and in particular embodiments, for drying cannabis. The method includes a step 702 of accessing data indicative of a heating efficiency threshold. This step is similar to step 602 described above.

Method 700 also includes a step 704 of accessing data indicative of a threshold time derivative of the number of excitation setups associated with heating efficiency larger than the heating efficiency threshold of step 702. This time derivative may be determined in advance, for example, in the factory manufacturing an oven that carries out the method.

Method 700 also includes a step 706 of accessing data indicative of a time derivative of the number of excitation setups associated with a heating efficiency larger than the heating efficiency threshold accessed in step 702. This data is generated during sweeping over excitation setups: in each sweep, each excitation setup is applied, its heating efficiency is measured, and associated therewith. The number of excitation setups associated with heating efficiency higher than the heating efficiency threshold is counted, e.g., during or after the sweeping. This number is recorded. When the excitation setups are swept again, the number is again recorded, and compared to the number recorded in the preceding sweep. The difference between them may be referred to as a time derivative of the number of efficient excitation setups. In some embodiments, the sweeping repeats more than twice, and the time derivative at the last repetition is calculated as known in the art.

Method 700 also includes a step 708 of comparing the time derivative of the number of efficient setups accessed in step 606 with the threshold time derivative accessed in step 704.

Finally, method 700 includes step 710, in which it is determined if to stop or continue the heating based on the comparison between the time derivative of the number of efficient excitation setups accessed at step 706 and the threshold time derivative accessed at step 704. For example, the determination may be to stop the heating only if the time derivative is smaller (i.e., more negative) than the threshold time derivative, while if it is larger than the threshold time derivative, heating continues.

Before explaining at least one embodiment of the present disclosure in detail, it is to be understood that the present disclosure is not necessarily limited in its application to the details of construction and the arrangement of the components and/or methods set forth in the following description and/or illustrated in the drawings. Features described in the current disclosure, including features of the invention, are capable of other embodiments or of being practiced or carried out in various ways . . . .

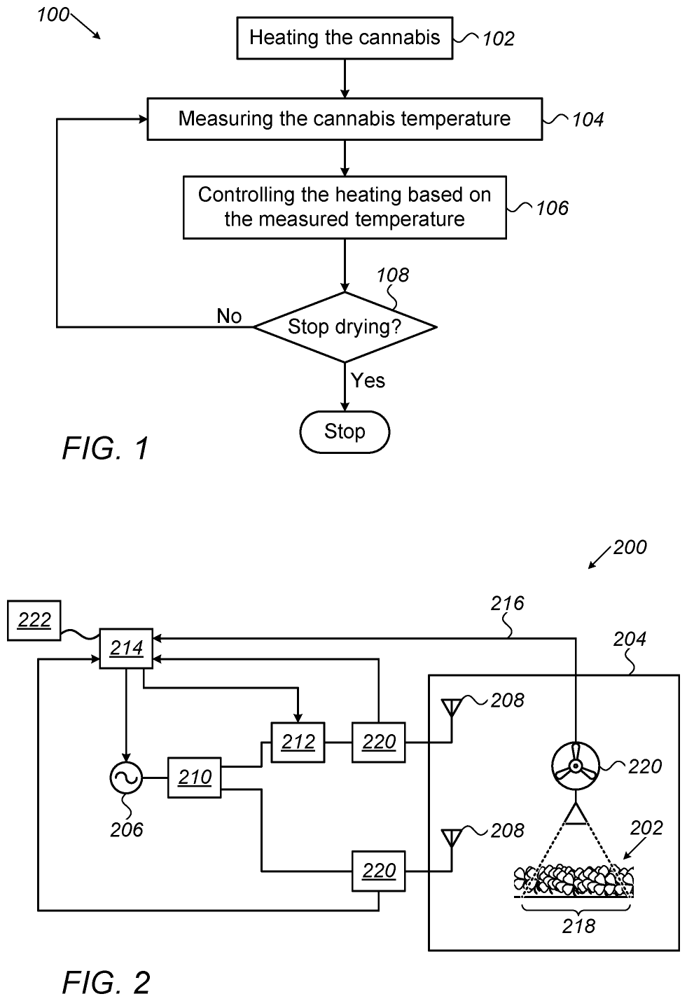

FIG. 1 is a flowchart of a method 100 of drying cannabis, according to some embodiments of the presently disclosed inventions. FIG. 2 is a diagrammatic representation of an oven 200 configured to carry out method 100, according to some embodiments. The method includes a step 102 of heating the cannabis 202. The cannabis is preferably heated in a cavity 204 of oven 200.

Oven 200 preferably includes a variable frequency microwave source 206 and at least two radiating elements 208. Optionally, oven 200 includes means for controlling a phase shift between waves transmitted via the various radiating elements 208. For example, each radiating element may be fed from a different DDS (direct digital synthesizer), and the DDSs may have a common clock. The DDS and the clock are not shown in the figure. In another example, signals from the microwave source 206 may be split by a splitter 210, and at least one of the split signals is directed to one of radiating elements 208 via a phase shifter 212. If more than two radiating elements are used, each one of them (possibly except for one, used as a reference) may be fed via a respective phase shifter 212, and the phase shifters may be controlled, independently of each other, by a processor 214. Processor 214 may also control the frequency generated by source 206. In some embodiments, source 206 includes an amplifier, optionally a variable amplifier, and processor 214 may also control the amplifier. In some embodiments (not shown) the amplifier is external to source 206. In some embodiments, each radiating element 208 has a respective amplifier, so that the splitter and phase shifter may deal with low-power signals. In such embodiments, processor 214 may control all the amplifiers to output at each time signals of the same power.

The combined control of frequency and phase may allow supplying cavity 204 with a plurality of different excitation setups, for example, a plurality of different frequency-phase combinations. Optionally, for example, when two or more of the at least two excitation setups differ from each other by their frequency component, cavity 204 may be sized to support at least two modes in a frequency range spanned by the at least two excitation setups.

Method 100 further includes a step 104 of measuring temperature of a portion of the cannabis to be dried, for example, by thermometer 216. Thermometer 216 may be, in some embodiments, an IR thermometer. Preferably, IR thermometer 216 has a field of view 218 of at least 1 cm square. Preferably, the field of view 218 of thermometer 216 encompasses between quarter and half (e.g., third) of the outer surface of cannabis 202. The temperature may be measured at different times during the heating, so that thermometer 216 may provide processor 214 with feedback regarding the progression of the temperature of cannabis 202.

Method 100 further includes a step 106 of controlling the heating, e.g., by processor 214, based on the temperature measured so that the cannabis is kept at a predetermined temperature range for a predetermined time period, for example, to temperatures above 30° C. and below 100° C., for at least 20 minutes.

In some embodiments, step 106 includes controlling, e.g., by processor 214, the total microwave power applied to the cavity by source 206 based on data the temperature measured. For example, processor 214 may receive from thermometer 216 data indicative to the temperature currently measured by the thermometer, and control source 206 accordingly. For example, at each excitation setup the power applied to the cavity may be given by the formula

P=α(T_{measured}−T_{target}) (Eq. 5)

wherein P is the power applied at each excitation setup, T_{target} is the target temperature, or, if there is a target temperature range, a temperature inside the range or one edge of that range, T_{measured} is the cannabis temperature as measured by the thermometer, and a is a proportionally constant, having units of Watt/° C. (or any other unit of power divided by temperature).

In some embodiments, step 106 comprises controlling the heating based on feedback indicative of a heating efficiency of each of the at least two excitation setups. For example, each radiating element 208 may be coupled to a respective RF detector 220, connected to processor 214 so as to provide the processor with data indicative of the power detected by detector 220 to go forward, into cavity 214, as well as data indicative of the power detected by the detector to go backward, from cavity 214. The detector 220 may include, for example, a dual directional coupler and a voltmeter. In some embodiments, the heating may be controlled so that a substantially equal amount of energy is absorbed in the cavity at each of the excitation setups, e.g., at each of the different frequency-phase combinations. Optionally, detectors 220 are arranged in the cavity, or, as illustrated, around the cavity. The detectors may be configured to provide the processor with feedback indicative of an absorption efficiency of each of the at least two excitation setups. For example, by providing the processor with measurements results of voltages going forward and backward through each radiating element, detectors 220 may provide processor 214 with sufficient information to allow processor 214 to calculate DR for each excitation setup, e.g., by equation 3 or 4.

In some embodiments, processor 214 is configured to set a value for the amount of energy (or the power level) to be applied to the cavity via the radiating elements, and to control the heating based on the set value. For example, the value may be set based on the measured temperature, e.g., using equation 1 above (provided the target temperature and the parameter a are provided to the processor, or predetermined by the processor, e.g., based on data received via user interface 222.

In some embodiments, method 100 further includes a step 108 of deciding, e.g., by processor 214, if drying is to be stopped. If so, the drying is stopped (step 110). Otherwise, drying continues, e.g., by returning to step 104 to measure the cannabis temperature again, and repeating step 106 to control further heating of the cannabis based on the newly measured temperature.

In some embodiments, while method 100 is being practiced to dry the cannabis 202, air in the vicinity of cannabis 202 is replaced with new air, which is preferably drier than the air being replaced. In some embodiments, the new air is also cooler than the air being replaced, therefore, the rate of air replacement may be used to control the cannabis temperature. For example, when the cannabis temperature is far from the target temperature, air replacement may be stopped (or not started), and when the target temperature is approached, air replacement may be started to slow down the temperature rising and allow for more gradual heating.

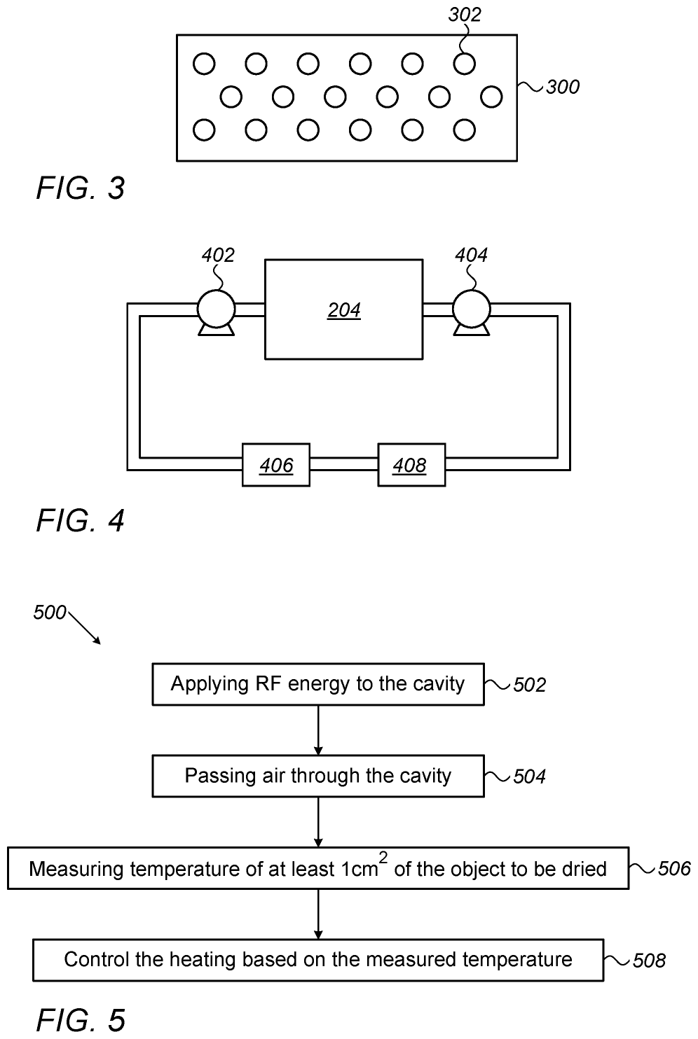

In some embodiments, air replacement is carried out by blowing air outside of cavity 202, e.g., with fan 220 towards the front door 300 (see FIG. 3) of cavity 204. In some embodiments, cavity door 300 includes openings 302 configured to allow air to leave the cavity freely, while preventing microwave leakage via the openings. For example, the openings may be much smaller than the smaller wavelength used for the drying.

FIG. 4 is a diagrammatical illustration of a system for air replacement according to some embodiments of the invention. In the illustrated system, air in the vicinity of the cannabis being dried is taken out of the cavity by pump 402, and replaced with new air taken from within the cavity, by pump 404. In the embodiment depicted in FIG. 4, the air may be pumped out of cavity 204 by a pump 402, and directed back to the cavity via pump 404, after going through a heat exchanger 406 and a desiccant 408.

FIG. 5 is a flowchart of method 500 of drying an object in a cavity. The object may be (or include) cannabis buds, but method 500 may also be used for drying other objects, such as leaves and plants. Method 500 includes a step 502 of applying to the cavity RF energy at frequencies that excite in the cavity, when the cavity is empty, a plurality of modes. The method further includes a step 504 of passing air through the cavity to reduce humidity in the vicinity of the object; a step 506 of measuring temperature of at least 1 cm square of the object; and a step 508 of controlling the application of the RF energy based on the measured temperature to retain the temperature within a predetermined temperature range. A skilled person can easily carry out each of these steps based on the description provided above and his general knowledge.

In an exemplary embodiment, either of drying cannabis or of drying or heating other substance, the drying or heating is made in cycles. In the following, heating is referred to, but drying may be similarly applied, regardless if the process brings to temperature increase or not. Each cycle may be of about 15, 20, or 30 seconds long, or any shorter, longer, or intermediate length. Each cycle is divided to two portions: a measuring portion and a heating portion. The measuring portion duration may be about 5% to 20% of the entire heating cycle duration.

During the measuring portion, processor 214 controls electromagnetic waves to be inputted into the cavity at each of the excitation setups that participate in the heating. These may be all the excitation setups available to apparatus 200 or a predetermined partial set of the available excitation setups. For example, the heating may be predetermined to use all frequencies between 2400 MHz and 2500 MHz in one MHz steps, and at each frequency to use a predetermined number of phases, for example, the 6 phases 0°, 60° . . . 300°. In the above example of six phases and 100 frequencies, 600 excitation setups are swept during the measurement portion of the heating cycle. At each excitation setup, a respective DR level (or other absorption indicator) is calculated, for example, from power measurements, and recorded in association with the respective excitation setup. The DR measurements at each excitation setup may be very short: long enough to stabilize the apparatus to operate at the excitation setup and carry out the measurement. This may be, in some embodiments, between 5 and 20 milliseconds.

Based on the recorded DR values, excitation setups are selected for heating. In one example of selecting excitation setups for heating, all excitation setups associated with a DR larger than a predetermined threshold (for example, each excitation setup associated with DR value larger than 0.6) is selected for heating. In another example, a predetermined portion (e.g., a quarter, third, half, etc.) or number (e.g., 100, 200, 300, etc.) of the excitation setups, associated with the highest DR values, are selected. In another example, a predetermined portion of the excitation setups associated with DR values higher than a predetermined threshold are selected.

A power level is selected for each selected excitation setup based on the difference between a temperature measured for the object, and a target temperature, for example, in accordance with Eq. 5. In some embodiments, different power levels may be selected for different excitation setups, for example, based on the DR values associated with them. For example, in some embodiments, the parameter a in Eq. 5 may be replaced by α/DR, α(1−DR), or any other function of DR.

A time duration is also selected for each selected excitation setup. For example, in some embodiments, the duration of the heating portion of the cycle is divided by the number of selected excitation setups, to obtain a quotient β, and the time duration, for which each excitation setup is used for heating, may be equal to said quotient β.

In some embodiments, the power levels and time durations are selected so that the energy absorbed at each excitation setup is the same. Thus, for example, the power level may be given by Equation 5 with a being replaced by α/DR and the time duration may be β. In another example, the time duration may be proportional to β/DR, and the power may be according to equation 5. The proportionality factor may be computed so that the total duration time will equate the time predetermined for the heating portion of the cycle. In preferred embodiments, the multiplicative product of the time duration and absorbed power level (the latter being input power level multiplied by DR) is the same for all the excitation setups.

Once excitation setups and respective power levels and time durations are selected, each excitation setup is used for heating the object at the set power level and time duration. After all the selected excitation setups are used, it is checked if a stopping criterion has been reached, and if so, heating is stopped; otherwise, another cycle begins, with a measurement portion.

The stopping criterion may be, for example, if the object is being heated for a predetermined period of time (e.g., three hours). In some embodiments, the stopping criterion is that the number of efficient excitation setups (e.g., excitation setups associated with a DR value larger than a predetermined DR threshold) is below a predetermined number-threshold. In some embodiments, the stopping criterion is that the number of efficient excitation setups decreases by a rate larger than a predetermined decrease threshold.

FIG. 6 is a simplified flowchart of a method 600 of determining if to stop or continue with heating by microwaves, e.g., for drying, and in particular embodiments, for drying cannabis. The method includes a step 602 of accessing data indicative of a heating efficiency threshold. In some embodiments, excitation setups associated with heating efficiency lower than the threshold are not used for the heating. Nevertheless, in some embodiments, a decision whether to select an excitation setup for heating or not does not necessarily depend on the heating efficiency threshold. For example, in some embodiments all the excitation setups are used for the heating regardless of their heating efficiency (even if not for the same time periods and/or at the same power levels). In some embodiments, the decision whether to use an excitation setup for heating or not depends on a different threshold, e.g., a second heating efficiency threshold that may be higher or lower than the first. In some embodiments, the selection of excitation setups for heating may be based on other criteria as described herein. The heating efficiency threshold accessed in that step of the method may be determined in advance, for example, in the factory manufacturing an oven that carries out the method or by input from a user, before heating commences.

Method 600 also includes a step 604 of accessing data indicative of a threshold number of excitation setups. This number may also may be determined in advance, for example, in the factory manufacturing an oven that carries out the method or by input from a user, before heating commences.

Method 600 also includes a step 606 of accessing data indicative of a number of excitation setups associated with a heating efficiency larger than the heating efficiency threshold accessed in step 602. This data is generated during sweeping over excitation setups: each excitation setup is applied, its heating efficiency is measured, and associated therewith. The number of excitation setups associated with heating efficiency higher than the heating efficiency threshold is counted, e.g., during or after the sweeping.

Method 600 also includes a step 608 of comparing the number of excitation setups accessed in step 606 with the threshold number of excitation setups accessed in step 604.

Finally, method 600 includes step 610, in which it is determined if to stop or continue the heating based on the comparison between the number of efficient excitation setups and the threshold number of excitation setups. For example, the determination may be to stop the heating only if the number of efficient excitation setups is smaller than the threshold number, while if it is larger than the threshold number, heating continues.

FIG. 7 is a simplified flowchart of a method 700 of determining if to stop or continue with heating by microwaves, e.g., for drying, and in particular embodiments, for drying cannabis. The method includes a step 702 of accessing data indicative of a heating efficiency threshold. This step is similar to step 602 described above.

Method 700 also includes a step 704 of accessing data indicative of a threshold time derivative of the number of excitation setups associated with heating efficiency larger than the heating efficiency threshold of step 702. This time derivative may be determined in advance, for example, in the factory manufacturing an oven that carries out the method.

Method 700 also includes a step 706 of accessing data indicative of a time derivative of the number of excitation setups associated with a heating efficiency larger than the heating efficiency threshold accessed in step 702. This data is generated during sweeping over excitation setups: in each sweep, each excitation setup is applied, its heating efficiency is measured, and associated therewith. The number of excitation setups associated with heating efficiency higher than the heating efficiency threshold is counted, e.g., during or after the sweeping. This number is recorded. When the excitation setups are swept again, the number is again recorded, and compared to the number recorded in the preceding sweep. The difference between them may be referred to as a time derivative of the number of efficient excitation setups. In some embodiments, the sweeping repeats more than twice, and the time derivative at the last repetition is calculated as known in the art.

Method 700 also includes a step 708 of comparing the time derivative of the number of efficient setups accessed in step 606 with the threshold time derivative accessed in step 704.

Finally, method 700 includes step 710, in which it is determined if to stop or continue the heating based on the comparison between the time derivative of the number of efficient excitation setups accessed at step 706 and the threshold time derivative accessed at step 704. For example, the determination may be to stop the heating only if the time derivative is smaller (i.e., more negative) than the threshold time derivative, while if it is larger than the threshold time derivative, heating continues.

A microwave oven configured to implement method 600 or 700 is depicted in FIG. 2, provided that processor 214 is configured to determine if the heating is to be stopped or continued according to said methods, and to stop or continue the heating accordingly.

General

As used herein with reference to quantity or value, the term “about” means “within 10% of”.

The terms “comprises”, “comprising”, “includes”, “including”, “has”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular forms “a”, “an” and “the” include plural references unless the context clearly dictates otherwise. For example, the term “a compound” or “at least one compound” may include a plurality of compounds, including mixtures thereof.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-50. (canceled)

51. A method of drying cannabis, comprising:
heating the cannabis in a cavity of a variable frequency microwave oven using at least two different excitation setups;
measuring temperature of at least 1 cm square of the cannabis at different times during the heating; and
controlling the heating based on the temperature measured so that the cannabis is kept for at least 20 minutes at temperatures above 30° C. and below 100° C.

52. The method of claim 51, wherein controlling the heating comprises controlling the total microwave power applied to the cavity based on the temperature measured.

53. The method of claim 51, wherein controlling the heating comprises controlling based on feedback received from at least one RF detector in or around the cavity, the feedback being indicative of a heating efficiency of each of the at least two excitation setups.

54. The method of claim 51, wherein controlling the heating comprises controlling so that a substantially equal amount of energy is absorbed in the cavity at each of the at least two excitation setups.

55. The method of claim 54, wherein each of said at least two excitation setup is a frequency-phase combination.

56. The method of claim 54, further comprising setting a value for the equal amount of energy, and controlling the heating based on the set value.

57. The method of claim 56, wherein setting the value comprises setting based on the measured temperature.

58. The method of claim 57, wherein replacing with new air comprises: circulating air inside the cavity.

59. The method of claim 58, wherein the circulating the air comprises drying and cooling the air taken.

60. The method of claim 59, further comprising collecting residues from the cooled air.

61. The method of claim 60, further comprising repeatedly replacing existing air in the vicinity of the cannabis with new air, which is drier and cooler than the existing air.

62. The method of claim 51, wherein the cannabis is dried under atmospheric pressure.

63. A cannabis drying oven comprising:
a cavity for receiving therein the cannabis to be dried;
a variable frequency microwave source configured to feed the cavity with microwaves of at least two different excitation setup;
a thermometer, configured to measure temperature of at least 1 cm square of the cannabis in the cavity during heating by the microwaves; and
a processor, configured to control the variable frequency microwave source based on readings received from the thermometer, to heat the cannabis to temperatures of between 30° C. and 100°.

64. The cannabis drying apparatus of claim 63, wherein the processor is configured to control the microwave power applied by the source to the cavity based on the temperature measured by the thermometer.

65. The cannabis drying oven of claim 63, wherein the cavity is sized to support at least two modes in a frequency range spanned by the at least two excitation setups.

66. The cannabis drying oven of claim 63, wherein the thermometer is an IR thermometer.

67. The cannabis drying oven of claim 66, wherein the IR thermometer has a field of view encompassing at least a quarter of the cannabis to be heated.

68. The cannabis drying oven of claim 63, further comprising at least one detector arranged in or around the cavity and configured to provide the processor with feedback indicative of an absorption efficiency of each of the at least two excitation setups.

69. The cannabis drying oven of claim 63, wherein the processor is configured to control the heating so that a substantially equal amount of energy is absorbed in the cavity at each of the at least two excitation setups.

70. The cannabis drying oven of claim 69, wherein the processor is further configured to set a value for the equal amount of energy, and control the heating based on the set value.

71. The cannabis drying oven of claim 70, wherein the processor is configured to set the value of the equal amount based on readings received from the thermometer.

72. The cannabis drying oven of claim 63 further comprising a pump, configured to repeatedly replace existing air in the vicinity of the cannabis with new air, which is drier and cooler from the existing air.

73. The cannabis drying oven of claim 72, wherein the pump is configured to replace air from the vicinity of the cannabis with air from outside the cavity.

74. The cannabis drying oven of claim 72, wherein the pump is configured to circulate air inside the cavity, through a heat exchange and a desiccant.
